(19) United States
(12) Patent Application Publication
(10) Pub. No.: US 2019/0200624 A1
(43) Pub. Date: Jul. 4, 2019

(54) NUTRITIONAL COMPOSITIONS AND METHODS OF USING SAME

(71) Applicant: Martin R. Lange, Wiesbaden (DE)

(72) Inventor: Martin R. Lange, Wiesbaden (DE)

(21) Appl. No.: 16/328,681

(22) PCT Filed: Aug. 30, 2017
(86) PCT No.: PCT/IB2017/001234

§ 371 Date: Feb. 26, 2019

Related U.S. Application Data
(60) Provisional application No. 62/382,171, filed on Aug. 31, 2016.

(51) Int. Cl. A21D 13/06; A21D 2/16; A21D 2/18; A23L 2/38; A23L 33/12; A23L 33/17; A23L 33/21; A23L 33/00

(52) U.S. Cl. CPC A21D 13/06; A23V 2250/70; A21D 2/181; A23L 2/38; A23L 33/12; A23L 33/17; A23L 33/21; A23L 33/30; A23L 33/40; A23V 2002/00; A23V 2200/26; A23V 2200/308; A23V 2200/31; A23V 2200/326; A23V 2200/328; A23V 2200/332; A23V 2250/156; A23V 2250/54; A23V 2250/64; A21D 2/165

(57) ABSTRACT

Described are compositions that can be used for medical purposes such as weight loss, obesity, diabetes control and the like. Methods of using these compositions are also described.

### CROSS REFERENCE TO RELATED APPLICATIONS

This application claims the benefit of U.S. provisional patent application No. 62/382,171, filed Aug. 31, 2016, the entire disclosure of which is incorporated herein by reference.

### FIELD

Described herein are compositions that can be used for medical purposes such as weight loss, diabetes control and the like. Methods of using these compositions are also described.

### BACKGROUND

Many programs exist to aid in losing weight or controlling a medical condition. However, many of these programs are not convenient, obtrusive, and the food tastes terrible. As a result, these programs are not adhered to thereby eliminating any long time benefit.

### SUMMARY

Described herein are nutritional compositions. These compositions can be used for medical purposes that can include, but are not limited to weight loss and diabetes management. Further, the compositions can assist in reducing the risk of cardiovascular disease, diabetes, inflammation, and cancer.

The nutritional compositions can be taken indefinitely or can be taken for a limited period of time.

In one embodiment, nutritional compositions are described that include less than about 20 g, less than about 35 g, less than about 40 g of net carbohydrate per day, less than about 50 g of net carbohydrate per day, less than about 75 g of net carbohydrate per day, less than about 100 g of net carbohydrate per day, or less than about 110 g of net carbohydrate per day. Further, the nutritional compositions can include at least 20 mg of fiber per day; and about 50 g to about 125 g of protein per day.

In some embodiments, the nutritional compositions can include about 1.0 g to about 2.5 g per kilogram of protein per day based on ideal body weight and/or an individual's height. In some embodiments, the nutritional composition can be consumed in at least five daily intakes. In some embodiments, the nutritional composition can be administered in at least eight daily intakes. In some embodiments, the nutritional composition can be administered in at least nine daily intakes.

In some embodiments, the nutritional composition is in a liquid form, in a solid form, or in a powder form.

In some embodiments, the nutritional composition can include about 10 g to about 50 g of net carbohydrate per day. In other embodiments, the nutritional composition can include about 30 g to about 60 g of net carbohydrate per day. Further, the nutritional composition can include at least about 26 g of fiber per day or from about 10 g to about 50 g of fiber per day. In other embodiments, the nutritional composition can include from about 15 g to about 50 g of fiber per day or about 15 g to about 20 g of fiber per day.

In other embodiments, the nutritional composition can include about 2,000 mg to about 12,000 mg of fatty acids per day. The fatty acids can include, but are not limited to omega, 3, omega 6, and/or omega 9. In one embodiment, the fatty acid is omega 3. When both an omega 3 and omega 6 are included, the ratio of omega 3 to omega 6 can be about 1:1. The nutritional compositions can contain enough omega 3 and omega 9, capturing the benefits of the Mediterranean diet, as well as enough dietary fiber to promote digestive health.

Other embodiments of the nutritional composition can include at least one amino acid selected from phenylalanine, valine, threonine, tryptophan, methionine, leucine, isoleucine, lysine and histidine. In some embodiments, the nutritional composition can include all the amino acids that a human cannot synthesize.

In still other embodiments, the nutritional composition further comprises a component selected from the group consisting of vitamins, minerals, essential amino acids, or a combination thereof. In some embodiments, the nutritional compositions can include recommended electrolytes, vitamins, and minerals as outlined by the National Institute of Health (NIH).

In some embodiments, the nutritional composition may include no meat, thus addressing the World Health Organization's (WHO) most recent concerns about impact of meat on cancer risk. However, in some embodiments, the nutritional composition may include meat.

In some embodiments, the nutritional compositions can include sugar alcohol at amounts from about 5 g to about 40 g per day. In other embodiments, the nutritional compositions can include sugar alcohol at amounts from about 5 g to about 10 g per day. In still other embodiments, the nutritional compositions can include sugar alcohol at amounts from about 25 g to about 35 g per day.

The nutritional compositions can contain high, but safe amounts of protein to preserve lean body mass.

In some embodiments, the nutritional compositions are not shakes, nasogastric liquids, or pills. The nutritional compositions can be real food that is sweet, salty, or sweet and salty.

Further still, the nutritional compositions can contain low amounts of cholesterol (<300 mg/day) and saturated fat. In other embodiments, the nutritional compositions can include less than about 300 mg of cholesterol per day. In still other embodiments, the nutritional compositions can include less than about 150 mg of cholesterol per day. In still other embodiments, the nutritional compositions can include less than about 100 mg of cholesterol per day.

In some embodiments, the nutritional compositions can be tailored to 3 different body size categories (e.g., based on height). When tailored to body size categories, the nutritional compositions can eliminate the need for ongoing, costly support or monthly subscriptions.

In some embodiments, the nutritional compositions may not require refrigeration, cooking, or preparation. Thus, the nutritional compositions can be eaten anytime, anywhere, addressing today's hectic lifestyles.

In some embodiments, a system is described comprising: a set of bars including the daily nutrient values described herein in a unifying container. In some embodiments, the unifying container includes instructions for use. In some embodiments, the unifying container includes at least five bars. In other embodiments, the unifying container includes at least eight bars.

In some embodiments, a system is described comprising: a set of bags including the daily nutrient values described herein in a unifying container. In some embodiments, the unifying container includes instructions for use. In some embodiments, the unifying container includes at least five bags. In other embodiments, the unifying container includes at least seven bags.

### DETAILED DESCRIPTION

Described herein are nutritional compositions that can be used for medical purposes. In some embodiments, the nutritional compositions may not be used for medical purposes, but rather for comfort, religious, political or other purposes.

The presently described nutritional compositions can enable individuals to live more fulfilled lives through improved health and wellbeing, while reducing the overall healthcare cost burden in the world. The nutritional compositions can provide full meal replacements to achieve weight loss and reduce risk of cardiovascular disease (CVD), diabetes, cancer, arthritis, Crohn's disease, inflammation disorders, and the like through personalized portions that can be consumed by any individual, anytime, anywhere.

In today's lifestyle, individuals tend to sit for long hours with increased stress and less leisure time (cash rich, time poor). Many individuals actually prefer taste and convenience over health and wellness. However, a growing facet of the population may be seeking more natural and healthier foods over packaged processed food. Thus, there is a need for the nutritional compositions described herein that can assist individuals while tasting good and being convenient.

When used for medical purposes, the nutritional compositions can be used to reduce weight and/or to treat obesity or excess weight (e.g., overweight). Generally, obesity can be defined as an individual having a body mass index (BMI) of greater than 30 and overweight can be defined as an individual having a BMI between 25 and 30. Further, the compositions can assist in reducing the risk of and/or treating cardiovascular disease and/or cancer.

The nutritional compositions can also be used to treat diabetes and/or slow the onset of diabetes. The nutritional compositions can be used by Type 1 diabetics, Type II diabetics and gestational diabetics. The nutritional compositions can work to reduce diabetic insulin delivery and/or the need for some diabetic medications.

In some embodiments, the nutritional compositions described herein can be tailored to provide composition portions with particular foods for which individuals have intolerance. Thus, nutritional compositions can be provided that do not include gluten, nuts, lactose, berries, corn, eggs, dairy, and the like.

In other embodiments, the nutritional compositions described herein can be tailored to provide composition portions with particular foods for which individuals have a dietary preference. Nutritional compositions can be provided that are vegetarian, vegan, Atkins, and the like.

In other embodiments, the nutritional compositions described herein can be tailored to provide composition portions for individuals with different activity levels. Nutritional compositions can be provided that are tailored for more athletic people or more inactive people.

Further, in other embodiments, the nutritional compositions described herein can be tailored to provide food based on a particular type of cuisine. Nutritional compositions can be provided that taste like Mexican food, Mediterranean food, Chinese food, Japanese food, Korean food, Russian food, Persian food, Middle Eastern food, American food, and the like.

In some embodiments, nutritional compositions can be provided that are tailored for men or women.

In some embodiments, the nutritional compositions can be provided and/or consumed to treat obesity or to achieve weight loss. The percentage of overweight and obese people is increasing every year, and obesity is a disease that has reached epidemic proportions in certain countries. The health risks associated with being overweight and obese are numerous and it has been shown that these conditions contribute to morbidity and mortality of individuals suffering from diseases such as hypertension, stroke, diabetes mellitus type II, gallbladder disease and ischemic heart disease. The effective treatment of obesity, however, remains a largely unachieved goal.

Many conventional weight loss programs have focused on a total caloric intake reduction through a fat intake reduction. Clinical studies have shown that very low fat diets do not provide better weight loss or an improved lipid profile when compared to low carbohydrate diets. Low carbohydrate diets by contrast are often associated with elevated or even high saturated fat and cholesterol intakes, as well as with very low intakes of dietary fiber per day. In some embodiments, conventional weight loss programs balance weight loss with unhealthy levels of fat and/or cholesterol. The herein described nutritional compositions solve the problems of conventional programs.

Many individuals subscribe to multiple diet plans in an effort to lose weight. In many instances, food cravings while on conventional diets can be quite acute and many stray from the dietary regimen. The herein described nutritional compositions may not result in increased cravings.

In some embodiments, the present nutritional compositions can provide (a) a reduced risk of cardiovascular disease through low saturated fat and cholesterol intakes, (b) safe weight loss and to improve HbA1C levels, with (c) high dietary fiber intakes to promote digestive health, and (d) omega 3 fatty acid and omega 9 fatty acid intakes to reduce the risk of cardiovascular disease, cancer and others. In one embodiment, the nutritional compositions can include less than about 20 g of net carbohydrate per day. In another embodiment, the nutritional compositions can include less than about 35 g of net carbohydrate per day. In another embodiment, the nutritional compositions can include less than about 40 g of net carbohydrate per day. In another embodiment, the nutritional compositions can include less than about 75 g of net carbohydrate per day. In another embodiment, the nutritional compositions can include less than about 110 g of net carbohydrate per day. These carbohydrates can be split over one or more portion.

The nutritional compositions can include at least 10 mg of fiber per day. In other embodiments, the nutritional compositions can include at least 15 mg of fiber per day. In other embodiments, the nutritional compositions can include at least 10 mg of fiber per day. This fiber can be in one portion or can be split over two or more portions. Further, the nutritional compositions can include from about 10 g to about 50 g of fiber per day. In other embodiments, the nutritional compositions can include from about 15 g to about 50 g of fiber per day or from about 15 g to about 20 g of fiber per day.

The nutritional compositions can contain high, but safe amounts of protein to preserve lean body mass. In some embodiments, the nutritional compositions can include about 50 g to about 125 g of protein per day.

In other embodiments, the nutritional compositions can include about 1.0 g to about 2.5 g of protein per kilogram of body weight per day based on ideal body weight and/or an individual height. This protein can be in one portion or can be split over two or more portions.

In some embodiments, the proteins can be plant based proteins such as, but not limited to, chia seeds, whey, and tofu.

In some embodiments, the nutritional composition can include about 10 g to about 50 g of net carbohydrate per day. In other embodiments, the nutritional composition can include about 30 g to about 60 g of net carbohydrate per day. Further, the nutritional composition can include at least about 10 g, at least about 15 g, at least about 20 g, at least about 25 g, or at least about 26 g of fiber per day. In other embodiments, the nutritional compositions can include from about 10 g to about 50 g of fiber per day or from about 15 g to about 20 g of fiber per day.

In other embodiments, the nutritional composition can include about 2,000 mg to about 12,000 mg of fatty acids per day. In some embodiments, the fatty acids can include an omega 3 or an omega 6. In some embodiments, the fatty acids can include eicosapentaenoic acid and/or docosahexaenoic acid. In some embodiments, the nutritional composition can include an omega 3 and an omega 6. When both an omega 3 and omega 6 are included, the ratio of omega 3 to omega 6 can be about 1:1. The nutritional compositions can contain enough omega 3 and omega 9, capturing the benefits of the Mediterranean diet, as well as enough dietary fiber to promote digestive health. In one embodiment, the omega 3 is fish oil and/or the omega 9 is olive oil.

In some embodiments, nutritional compositions can include about 1.0-2.5 g of protein per kg of ideal bodyweight, less than about 1 g of total fatty acids, less than about 20 g of net carbohydrates, and/or at least about 26 g of fiber per day. In other embodiments, nutritional compositions can include about 2.0 g of protein per kg of ideal bodyweight, less than about 1 g of total fatty acids, less than about 20 g of net carbohydrates, and/or at least about 26 g of fiber per day.

In some embodiments, nutritional compositions can include about 1.0-2.5 g of protein per kg of ideal bodyweight, less than about 1 g of total fatty acids, less than about 20 g of net carbohydrates, and/or at least about 10 g of fiber per day. In other embodiments, nutritional compositions can include about 2.0 g of protein per kg of ideal bodyweight, less than about 1 g of total fatty acids, less than about 20 g of net carbohydrates, and/or at least about 10 g of fiber per day.

In some embodiments, nutritional compositions can include about 1.0-2.5 g of protein per kg of ideal bodyweight, less than about 1 g of total fatty acids, less than about 20 g of net carbohydrates, and/or at least about 15 g of fiber per day. In other embodiments, nutritional compositions can include about 2.0 g of protein per kg of ideal bodyweight, less than about 1 g of total fatty acids, less than about 20 g of net carbohydrates, and/or at least about 15 g of fiber per day.

In some embodiments, nutritional compositions can include about 1.0-2.5 g of protein per kg of ideal bodyweight, less than about 1 g of total fatty acids, less than about 35 g of net carbohydrates, and/or at least about 26 g of fiber per day. In other embodiments, nutritional compositions can include about 2.0 g of protein per kg of ideal bodyweight, less than about 1 g of total fatty acids, less than about 35 g of net carbohydrates, and/or at least about 26 g of fiber per day.

In some embodiments, nutritional compositions can include about 1.0-2.5 g of protein per kg of ideal bodyweight, less than about 1 g of total fatty acids, less than about 35 g of net carbohydrates, and/or at least about 10 g of fiber per day. In other embodiments, nutritional compositions can include about 2.0 g of protein per kg of ideal bodyweight, less than about 1 g of total fatty acids, less than about 35 g of net carbohydrates, and/or at least about 10 g of fiber per day.

In some embodiments, nutritional compositions can include about 1.0-2.5 g of protein per kg of ideal bodyweight, less than about 1 g of total fatty acids, less than about 35 g of net carbohydrates, and/or at least about 15 g of fiber per day. In other embodiments, nutritional compositions can include about 2.0 g of protein per kg of ideal bodyweight, less than about 1 g of total fatty acids, less than about 35 g of net carbohydrates, and/or at least about 15 g of fiber per day.

In some embodiments, nutritional compositions can include about 1.0-2.5 g of protein per kg of ideal bodyweight, less than about 1 g of total fatty acids, less than about 40 g of net carbohydrates, and/or at least about 26 g of fiber per day. In other embodiments, nutritional compositions can include about 2.0 g of protein per kg of ideal bodyweight, less than about 1 g of total fatty acids, less than about 40 g of net carbohydrates, and/or at least about 26 g of fiber per day.

In some embodiments, nutritional compositions can include about 1.0-2.5 g of protein per kg of ideal bodyweight, less than about 1 g of total fatty acids, less than about 40 g of net carbohydrates, and/or at least about 10 g of fiber per day. In other embodiments, nutritional compositions can include about 2.0 g of protein per kg of ideal bodyweight, less than about 1 g of total fatty acids, less than about 40 g of net carbohydrates, and/or at least about 10 g of fiber per day.

In some embodiments, nutritional compositions can include about 1.0-2.5 g of protein per kg of ideal bodyweight, less than about 1 g of total fatty acids, less than about 40 g of net carbohydrates, and/or at least about 15 g of fiber per day. In other embodiments, nutritional compositions can include about 2.0 g of protein per kg of ideal bodyweight, less than about 1 g of total fatty acids, less than about 40 g of net carbohydrates, and/or at least about 15 g of fiber per day.

In some embodiments, nutritional compositions can include about 1.0-2.5 g of protein per kg of ideal bodyweight, less than about 1 g of total fatty acids, less than about 75 g of net carbohydrates, and/or at least about 26 g of fiber per day. In some embodiments, the compositions can include at least 38 g of fiber per day. In other embodiments, nutritional compositions can include about 2.0 g of protein per kg of ideal bodyweight, less than about 1 g of total fatty acids, less than about 75 g of net carbohydrates, and/or at least about 26 g of fiber per day.

In some embodiments, nutritional compositions can include about 1.0-2.5 g of protein per kg of ideal bodyweight, less than about 1 g of total fatty acids, less than about 75 g of net carbohydrates, and/or at least about 10 g of fiber per day. In some embodiments, the compositions can include at least 38 g of fiber per day. In other embodiments, nutritional compositions can include about 2.0 g of protein per kg of ideal bodyweight, less than about 1 g of total fatty acids, less than about 75 g of net carbohydrates, and/or at least about 10 g of fiber per day.

In some embodiments, nutritional compositions can include about 1.0-2.5 g of protein per kg of ideal bodyweight, less than about 1 g of total fatty acids, less than about 75 g of net carbohydrates, and/or at least about 15 g of fiber per day. In some embodiments, the compositions can include at least 38 g of fiber per day. In other embodiments, nutritional compositions can include about 2.0 g of protein per kg of ideal bodyweight, less than about 1 g of total fatty acids, less than about 75 g of net carbohydrates, and/or at least about 15 g of fiber per day.

In some embodiments, nutritional compositions can include about 1.0-2.5 g of protein per kg of ideal bodyweight, less than about 1 g of total fatty acids, less than about 110 g of net carbohydrates, and/or at least about 26 g of fiber per day. In other embodiments, nutritional compositions can include about 2.0 g of protein per kg of ideal bodyweight, less than about 1 g of total fatty acids, less than about 110 g of net carbohydrates, and/or at least about 26 g of fiber per day.

In some embodiments, nutritional compositions can include about 1.0-2.5 g of protein per kg of ideal bodyweight, less than about 1 g of total fatty acids, less than about 110 g of net carbohydrates, and/or at least about 10 g of fiber per day. In other embodiments, nutritional compositions can include about 2.0 g of protein per kg of ideal bodyweight, less than about 1 g of total fatty acids, less than about 110 g of net carbohydrates, and/or at least about 10 g of fiber per day.

In some embodiments, nutritional compositions can include about 1.0-2.5 g of protein per kg of ideal bodyweight, less than about 1 g of total fatty acids, less than about 110 g of net carbohydrates, and/or at least about 15 g of fiber per day. In other embodiments, nutritional compositions can include about 2.0 g of protein per kg of ideal bodyweight, less than about 1 g of total fatty acids, less than about 110 g of net carbohydrates, and/or at least about 15 g of fiber per day.

Other embodiments of the nutritional composition can include at least one amino acid selected from phenylalanine, valine, threonine, tryptophan, methionine, leucine, isoleucine, lysine and histidine. In some embodiments, the nutritional composition can include all the amino acids that a human cannot synthesize.

In still other embodiments, the nutritional composition further comprises a component selected from the group consisting of vitamins, minerals, essential amino acids, or a combination thereof. In some embodiments, the nutritional compositions can include recommended electrolytes, vitamins, and minerals as outlined by the National Institute of Health (NIH).

In some embodiments, the nutritional composition may include no meat, thus addressing the World Health Organization's (WHO) most recent concerns about impact of meat on cancer risk. However, in some embodiments, the nutritional composition may include meat.

Further still, the nutritional compositions can include low amounts of cholesterol (<300 mg/day) and saturated fat per day. In other embodiments, the nutritional composition can include less than about 300 mg of cholesterol per day. In still other embodiments, the nutritional composition can include less than about 100 mg of cholesterol per day.

The nutritional compositions can be ingested and/or described as real food. In other embodiments, the nutritional compositions can be generally regarded as safe (GRAS). In some embodiments, the nutritional composition is in a liquid form, in a solid form, or in a powder form. Other forms can include a paste, a gel, a bar, a soup, a patty, a salad, a compote, a dressing, a casserole, a sauce, wafer, a biscuit, a bite sized portion, a lozenge, a chewable tablet, a stew, a stuffing, a reconstituted meat substitute, a blend, a wrap, a combination thereof, or the like. In some embodiments, the nutritional compositions are not shakes, nasogastric liquids, or pills. However, in some embodiments, the nutritional compositions can include beverages. The nutritional compositions can be real food that is sweet, salty, or sweet and salty.

The nutritional compositions can be taken indefinitely or can be taken for a limited period of time. In some embodiments, the nutritional compositions can be taken for about 1 week, about 2 weeks, about 3 weeks, about 1 month, about 2 months, about 3 months, about 4 months, about 5 months, about 6 months, about 1 year, about 2 years, or more. In other embodiments, the nutritional compositions can be taken about for about 1 week to about 2 weeks, for about 2 weeks to about 3 weeks, for about 3 weeks to about 1 month, for about 1 month to about 2 months, for about 2 months to about 3 months, for about 3 months to about 4 months, for about 4 months to about 5 months, for about 5 months to about 6 months, for about 6 months to about 1 year, for about 1 years to about 2 years, or more. In other embodiments, the nutritional compositions can be taken indefinitely or can be taken for a limited period of time.

In some embodiments, the nutritional compositions may not require refrigeration, cooking, or preparation. Thus, the nutritional compositions can be eaten anytime, anywhere, addressing today's hectic lifestyles.

In some embodiments, the nutritional compositions can be planned or defined based on body height. Body height may not (significantly) change throughout a person's life after puberty. Using the equation for body mass index (BMI),

$$USA \to BMI = 703 \times \frac{weight ( lbs )}{{height}^{2} ( {in}^{2} )}$$

$$Metric \to BMI = \frac{weight ( kg )}{{height}^{2} ( {m}^{2} )}$$

one can calculate nutritional intake target amounts. Nutritional intake target amounts can be based on kilogram ideal body weight (BW). This is the weight of a person at a healthy body mass index (BMI). In one embodiment BMI can be 23 for a healthy bodyweight. In other embodiments, BMI values more or less than 23 can be used to more gradually increase or decrease an individual's weight.

Using a chosen BMI value and a constant body height, a target nutritional intake per kilogram ideal bodyweight based can be calculated. According to this method of calculating target nutritional intake, the taller the person the more nutritional intake he/she will need. In some embodiments, nutritional intake can be defined based on ideal bodyweight, not on current bodyweight.

In some embodiments, the nutritional compositions can be tailored to 3 different body size categories (e.g., based on height). When tailed to body size categories, the nutritional compositions can eliminate the need for ongoing, costly support or monthly subscriptions. However, in some embodiments, more or less than 3 different body size categories can exist. In some embodiments, 4, 5, 6, 7, 8, 9, 10 or more body size categories can exist. In some embodiments, body size categories can exist for men, women, or both men and women.

In an embodiment with 3 body size categories, a weighted average of people can be used to create the body size categories. In one embodiment, 3 body size categories can include (a) below 165 cm/below 5′5″, (b) between 165 cm-180 cm/between 5′5″-5′10″, and (c) above 180 cm/above 5′10″. Other categories can be created as needed.

In some embodiments, the nutritional composition can be consumed in at least five daily intakes. In other embodiments, the nutritional composition can be consumed in at least six daily intakes, at least seven daily intakes, at least eight daily intakes, at least nine daily intakes, at least ten daily intakes, at least eleven daily intakes, or at least twelve daily intakes.

In one embodiment, nine daily intakes can include a pre-breakfast portion, a breakfast portion, a post-breakfast/pre-lunch portion, a lunch portion, a post-lunch portion, an afternoon portion, a pre-dinner portion, a dinner portion, and a nighttime portion.

In one embodiment, eight daily intakes can include a pre-breakfast portion, a breakfast portion, a post-breakfast/pre-lunch portion, a lunch portion, a post-lunch portion, an afternoon portion, a dinner portion, and a nighttime portion.

In one embodiment, five daily intakes can include a breakfast portion, a post-breakfast/pre-lunch portion, a lunch portion, an afternoon portion, and a dinner portion.

In some embodiments, portions can be taken every hour, every two hours, every three hours, every four hours, or the like.

In some embodiments, an intake a nutritional composition can be in the form of a solid bar. In some embodiments, the bar is about 50 g in mass. A bar can include less than about 200 kcalories (kcal), less than about 180 kcal, between about 150 kcal and about 200 kcal, or between about 175 kcal and about 185 kcal. The bar can include less than about 10 g of fat, less than about 8 g of fat, or between about 7 g and about 8 g of fat. The bar can include less than about 2 g of saturated fat, less than about 1.2 g of saturated fat, or between about 1 g and about 1.5 g of saturated fat. In some embodiments, the bar can include no trans fat (also referred to herein as trans fatty acid). The bar can include less than about 3 g of poly fat, less than about 2 g of poly fat, or between about 1.5 g and about 2.5 g of poly fat. The bar can include less than about 5 g of mono fat, less than about 4 g of mono fat, or between about 3 g and about 4 g of mono fat. The bar can include less than about 20 mg of cholesterol, less than about 15 mg of cholesterol, or between about 14 mg and about 16 mg of cholesterol. The bar can include less than about 30 g of carbohydrates, less than about 25 g of carbohydrates, or between about 20 g and about 25 g of carbohydrates. The bar can include less than about 5 g of total sugars, less than about 4 g of total sugars, or between about 3 g and about 4 g of total sugars. The bar can include less than about 5 g of dietary fiber, less than about 4 g of dietary fiber, or between about 3 g and about 4 g of dietary fiber. The bar can include less than about 12 g of isomaltooligosaccharide, less than about 10 g of isomaltooligosaccharide, or between about 9 g and about 10 g of isomaltooligosaccharide. The bar can include less than about 8 g of sugar alcohol, less than about 6 g of sugar alcohol, or between about 5 g and about 6 g of sugar alcohol. The bar can include less than about 6 g of net carbs, less than about 5 g of net carbs, or between about 5 g and about 6 g of net carbs. The bar can include less than about 15 g of protein, less than about 12 g of protein, or between about 10 g and about 12 g of protein. The bar can include less than about 500 mg of total omega 3, less than about 450 mg of total omega 3, or between about 400 mg and about 500 mg of total omega 3. The bar can include less than about 400 mg of total omega 6, less than about 350 mg of total omega 6, or between about 300 mg and about 350 mg of total omega 6. The bar can include less than about 200 mg of sodium, less than about 150 mg of sodium, or between about 100 mg and about 200 mg of sodium. The bar can include less than about 150 mg of potassium, less than about 110 mg of potassium, or between about 100 mg and about 125 mg of potassium. The bar can include less than about 20 IU of vitamin A, less than about 15 IU of vitamin A, or between about 10 IU and about 20 IU of vitamin A. The bar can include less than about 1 mg of vitamin C, less than about 0.5 mg of vitamin C, or between about 0.25 mg and about 0.1 mg of vitamin C. The bar can include less than about 125 mg of calcium, less than about 110 mg of calcium, or between about 100 mg and about 125 mg of calcium. The bar can include less than about 2 mg of iron, less than about 1.5 mg of iron, or between about 0.5 mg and about 1.5 mg of iron.

In some embodiments, an intake a nutritional composition can be in the form of a biscuit. In some embodiments, the biscuit is about 30 g in mass. A biscuit can include less than about 200 kcalories (kcal), less than about 180 kcal, between about 150 kcal and about 100 kcal, or between about 150 kcal and about 125 kcal. The biscuit can include less than about 12 g of fat, less than about 10 g of fat, or between about 8 g and about 12 g of fat. The biscuit can include less than about 5 g of saturated fat, less than about 3 g of saturated fat, or between about 2 g and about 3 g of saturated fat. In some embodiments, the biscuit can include no trans fatty acid. The biscuit can include less than about 3 g of poly fat, less than about 2 g of poly fat, or between about 1.5 g and about 2.5 g of poly fat. The biscuit can include less than about 5 g of mono fat, less than about 4 g of mono fat, or between about 4 g and about 5 g of mono fat. The biscuit can include less than about 10 mg of cholesterol, less than about 7.5 mg of cholesterol, or between about 6 mg and about 7 mg of cholesterol. The biscuit can include less than about 20 g of carbohydrates, less than about 15 g of carbohydrates, or between about 10 g and about 15 g of carbohydrates. The biscuit can include less than about 5 g of total sugars, less than about 4 g of total sugars, or between about 2 g and about 3 g of total sugars. The biscuit can include less than about 5 g of dietary fiber, less than about 4 g of dietary fiber, or between about 3 g and about 4 g of dietary fiber. The biscuit can include less than about 5 g of isomaltooligosaccharide, less than about 4 g of isomaltooligosaccharide, or between about 3 g and about 4 g of isomaltooligosaccharide. The biscuit can include less than about 5 g of sugar alcohol, less than about 2 g of sugar alcohol, or between about 1 g and about 2 g of sugar alcohol. The biscuit can include less than about 6 g of net carbs, less than about 5 g of net carbs, or between about 4 g and about 5 g of net carbs. The biscuit can include less than about 5 g of protein, less than about 4 g of protein, or between about 3 g and about 4 g of protein. The bar can include less than about 400 mg of total omega 3, less than about 300 mg of total omega 3, or between about 200 mg and about 300 mg of total omega 3. The bar can include less than about 1,500 mg of total omega 6, less than about 1,400 mg of total omega 6, or between about 1,300 mg and about 1,400 mg of total omega 6.

In some embodiments, an intake a nutritional composition can be in the form of a flavored beverage. In one embodiment, the beverage is vanilla flavored. Other flavors are within the scope of the present disclosure. In some embodiments, the beverage is about 11 fluid ounces. A beverage can include less than about 100 kcalories (kcal), less than about 90 kcal, between about 80 kcal and about 90 kcal, or between about 80 kcal and about 100 kcal. The beverage can include less than about 5 g of fat, less than about 4 g of fat, or between about 1 g and about 3 g of fat. The beverage can include less than about 1 g of saturated fat, less than about 0.5 g of saturated fat, or between about 0.1 g and about 0.5 g of saturated fat. In some embodiments, the beverage can include no trans fatty acid. The beverage can include less than about 1 g of poly fat, less than about 0.5 g of poly fat, or between about 0.1 g and about 1 g of poly fat. The beverage can include less than about 2 g of mono fat, less than about 1.5 g of mono fat, or between about 1 g and about 1.5 g of mono fat. The beverage can include less than about 10 mg of cholesterol, less than about 7.5 mg of cholesterol, or between about 5 mg and about 10 mg of cholesterol. The beverage can include less than about 5 g of carbohydrates, less than about 2 g of carbohydrates, or between about 1 g and about 2 g of carbohydrates. The beverage can include less than about 1 g of total sugars, less than about 0.5 g of total sugars, or between about 0.1 g and about 1 g of total sugars. In some embodiments, the beverage may not include any dietary fiber. The beverage can include less than about 5 g of net carbs, less than about 2 g of net carbs, or between about 1 g and about 2 g of net carbs. The beverage can include less than about 20 g of protein, less than about 15 g of protein, or between about 12 g and about 15 g of protein. The beverage can include less than about 500 mg of total omega 3, less than about 200 mg of total omega 3, or between about 100 mg and about 200 mg of total omega 3. The beverage can include less than about 400 mg of total omega 6, less than about 350 mg of total omega 6, or between about 300 mg and about 350 mg of total omega 6. The beverage can include less than about 100 mg of sodium, less than about 75 mg of sodium, or between about 50 mg and about 100 mg of sodium. The beverage can include less than about 500 mg of potassium, less than about 250 mg of potassium, or between about 200 mg and about 300 mg of potassium. The beverage can include less than about 10 IU of vitamin A, less than about 5 IU of vitamin A, or between about 1 IU and about 5 IU of vitamin A. The beverage can include less than about 500 mg of calcium, less than about 400 mg of calcium, or between about 100 mg and about 500 mg of calcium. The beverage can include less than about 1 mg of iron, less than about 0.5 mg of iron, or between about 0.1 mg and about 0.5 mg of iron.

In some embodiments, an intake a nutritional composition can be in the form of another flavored beverage. In one embodiment, the beverage is vanilla flavored. Other flavors are within the scope of the present disclosure. In some embodiments, the beverage is about 11 fluid ounces. A beverage can include less than about 100 kcalories (kcal), less than about 75 kcal, between about 50 kcal and about 70 kcal, or between about 50 kcal and about 75 kcal. The beverage can include less than about 5 g of fat, less than about 4 g of fat, or between about 1 g and about 3 g of fat. The beverage can include less than about 1 g of saturated fat, less than about 0.5 g of saturated fat, or between about 0.1 g and about 0.5 g of saturated fat. In some embodiments, the beverage can include no trans fatty acid. The beverage can include less than about 1 g of poly fat, less than about 0.5 g of poly fat, or between about 0.1 g and about 1 g of poly fat. The beverage can include less than about 2 g of mono fat, less than about 1.5 g of mono fat, or between about 1 g and about 1.5 g of mono fat. The beverage can include less than about 10 mg of cholesterol, less than about 5 mg of cholesterol, or between about 1 mg and about 5 mg of cholesterol. The beverage can include less than about 5 g of carbohydrates, less than about 2 g of carbohydrates, or between about 1 g and about 2 g of carbohydrates. The beverage can include less than about 1 g of total sugars, less than about 0.5 g of total sugars, or between about 0.1 g and about 1 g of total sugars. In some embodiments, the beverage may not include any dietary fiber. The beverage can include less than about 5 g of net carbs, less than about 2 g of net carbs, or between about 1 g and about 2 g of net carbs. The beverage can include less than about 15 g of protein, less than about 10 g of protein, or between about 5 g and about 10 g of protein. The beverage can include less than about 500 mg of total omega 3, less than about 200 mg of total omega 3, or between about 100 mg and about 200 mg of total omega 3. The beverage can include less than about 400 mg of total omega 6, less than about 350 mg of total omega 6, or between about 300 mg and about 350 mg of total omega 6. The beverage can include less than about 100 mg of sodium, less than about 75 mg of sodium, or between about 50 mg and about 100 mg of sodium. The beverage can include less than about 500 mg of potassium, less than about 250 mg of potassium, or between about 200 mg and about 300 mg of potassium. The beverage can include less than about 10 IU of vitamin A, less than about 5 IU of vitamin A, or between about 1 IU and about 5 IU of vitamin A. The beverage can include less than about 0.05 mg of vitamin C, less than about 0.04 mg of vitamin C, or between about 0.01 mg and about 0.05 mg of vitamin C. The beverage can include less than about 500 mg of calcium, less than about 400 mg of calcium, or between about 100 mg and about 500 mg of calcium. The beverage can include less than about 0.5 mg of iron, less than about 0.1 mg of iron, or between about 0.01 mg and about 0.1 mg of iron.

In some embodiments, drinks, bars, and biscuits can be mixed to achieve a particular macronutrient goal. For example, in some embodiments, a combination can be provided that includes between about 1,000 and about 1,400 kcal per day. In one embodiment, the combination can include about 1,300 kcal per day. This combination can be provided for women, children, or a smaller man.

In another embodiment, a combination can be provided that includes between about 1,400 and about 1,700 kcal per day. In one embodiment, the combination can include about 1,500 kcal per day. This combination can be provided for men.

In other embodiments, a combination can be provided that includes between about 1,700 and about 2,000 kcal per day. In one embodiment, the combination can include about 1,800 kcal per day. This combination can be provided for women or men that are overweight.

In some embodiments, the nutritional compositions can be augmented with normal, non-nutritional composition foods. For example, particular portions can be replaced by normal foods. In some embodiments, nutritional composition portions in the morning can be replaced. In other embodiments, nutritional composition portions before lunch can be replaced. In still other embodiments, nutritional composition portions up to and including lunch can be replaced.

In some embodiments, nutritional compositions can be provided that are considered maintenance. During maintenance periods, an individual can eat normally for morning portions and use five or more nutritional composition portions in the afternoon/evening. Eating normally can be defined as eating what an individual wants in moderation which still avoiding carbohydrates and fats. In some embodiments, eating normally can be defined as eating as desired while consuming less than about 100 g of carbohydrates per day in the desired period. In other embodiments, eating normally can be defined as eating as desired while consuming less than about 150 g of carbohydrates per day in the desired period. If weight gain starts, an individual can restart a full replacement of meals with nutritional composition portions or can start replacing portions of nutritional compositions as needed to reduce weight or maintain a desired weight.

In some embodiments, the presently described nutritional compositions may allow an individual to save money when compared to a regular diet and/or other meal replacement products.

In some embodiments, the nutritional compositions described can achieve body weight reduction.

In some embodiments, the nutritional compositions described can achieve waist circumference reduction.

In some embodiments, the nutritional compositions described can achieve a reduction of fat mass/maintenance of lean body mass.

In some embodiments, the nutritional compositions described can achieve a reduction of LDL cholesterol.

In some embodiments, the nutritional compositions described can achieve an increase of HDL cholesterol.

In some embodiments, the nutritional compositions described can achieve a reduction of systolic blood pressure.

In some embodiments, the nutritional compositions described can achieve a reduction in blood glucose.

In some embodiments, the nutritional compositions described can achieve a reduction in blood insulin levels.

In some embodiments, the nutritional compositions described can achieve a reduction of inflammation markers (hs-CRP levels) and/or inflammation.

In some embodiments, the nutritional compositions described can achieve two or more of the above.

In some embodiments, in addition to the benefits above, the nutritional compositions can reduce constipation when compared to conventional weight loss diets.

Methods of using the nutritional compositions can include providing at least five daily portions to an individual to take a various intervals during the day.

Methods of using the nutritional compositions can include providing at least nine daily portions to an individual to take a various intervals during the day.

Methods of using the nutritional compositions can include providing at least five daily portions to an individual to take every two hours starting after lunch.

Methods of using the nutritional compositions can include providing at least five daily portions to an individual to take every two hours from the time they wake up in the morning.

Methods of losing weight using the nutritional compositions can include ingesting at least five daily portions to an individual to take a various intervals during the day.

Methods of losing weight using the nutritional compositions can include ingesting at least nine daily portions to an individual to take a various intervals during the day.

Methods of using the nutritional compositions can include providing an individual with nutritional composition portions based on the individual's ideal body weight and height.

Methods of using the nutritional compositions can include providing an individual with nutritional composition portions for 10 days.

Methods of using the nutritional compositions can include providing an individual with nutritional composition portions for 30 days.

Methods of using the nutritional compositions can include providing an individual with nutritional composition portions indefinitely for maintenance.

A method of treating obesity can include administering the nutritional composition described herein. A nutritional composition is described for use as a medicament to treat obesity.

A method of treating an overweight individual can include administering the nutritional composition described herein. A nutritional composition is described for use as a medicament to treat an overweight individual.

A method of weight loss can include administering the nutritional composition described herein. A nutritional composition is described for use as a medicament to achieve weight loss.

A method of treating cancer can include administering the nutritional composition described herein. A nutritional composition is described for use as a medicament to treat cancer.

A method of treating diabetes can include administering the nutritional composition described herein. A nutritional composition is described for use as a medicament to treat diabetes.

A method of treating arthritis can include administering the nutritional composition described herein. A nutritional composition is described for use as a medicament to treat arthritis.

A method of treating Crohn's disease can include administering the nutritional composition described herein. A nutritional composition is described for use as a medicament to treat Crohn's disease.

A method of treating inflammatory disorders can include administering the nutritional composition described herein. A nutritional composition is described for use as a medicament to treat an inflammatory disorder(s).

### EXAMPLE 1

A daily nutritional composition is provided as listed in Table 1. The nutritional composition is provided in 8 portions.

TABLE 1

| Nutrient | Amount |
|---|---|
| Total Food (g) | 394 |
| Total Energy (kcal) | 1630 |
| Total Carbohydrate (g) | 58.8 |
| Fiber (g) | 40.7 |
| Net Carbohydrate (g) | 18.0 |
| Protein (g) | 148.5 |
| Total Saturated Fats | 26.5 |
| Omega 3 ALA (g) | 9.1 |
| Omega 3 EPA (g) | 1.04 |
| Omega 3 DHA (g) | 1.46 |
| Omega 3 LA (g) | 12.0 |
| Omega 9 (g) | 39.5 |
| Cholesterol (mg) | 91.5 |

### EXAMPLE 2

A daily nutritional composition is provided as listed in Table 2. The nutritional composition is provided in 8 portions.

TABLE 2

| Nutrient | Amount |
|---|---|
| Total Energy (kcal) | 1337 |
| Total Carbohydrate (g) | 81.4 |
| Fiber (g) | 20.1 |
| Net Carbohydrate (g) | 32.5 |
| Protein (g) | 110.0 |
| Total Saturated Fats | 14.5 |
| Omega 3 ALA (g) | 2.5 |
| Omega 3 EPA + DHA (g) | 1.0 |
| Cholesterol (mg) | 74.6 |

### EXAMPLE 3

The nutritional compositions of Example 1 or Example 2 are provided to Type I and Type II diabetics. The diabetics see a reduction in insulin needs and a reduction in their hemoglobin A1C.

### EXAMPLE 4

The nutritional compositions of Example 1 or Example 2 are provided to individuals at risk of cardiovascular disease. These individuals see a reduction in HDL and/or LDL.

### EXAMPLE 5

The nutritional compositions of Example 1 or Example 2 are provided to arthritis sufferers. The arthritis sufferers see a reduction in inflammation.

### EXAMPLE 6

Daily nutritional compositions are provided in three categories based on an individual's height as listed in Table 3.

TABLE 3

| | Individual Height | | |
|---|---|---|---|
| | Below | | Above |
| Height Category | 165 cm | 165 cm-180 cm | 180 cm |
| BMI | 23 | 23 | 23 |
| Ideal Body Weight (kg) | 58.9 | 72.1 | 78.7 |
| Total Protein (g) | 117.8 | 114.1 | 157.4 |
| Omega 3 PUFA - EPA (g) | 0.5 | 0.5 | 0.5 |
| Omega 3 PUFA - DHA (g) | 0.5 | 0.5 | 0.5 |
| Omega 9 MUFA (g) | 35.3 | 43.2 | 47.2 |
| Dietary Fiber (g) | 38.0 | 38.0 | 38.0 |
| Net Carbohydrates (g) | 20.0 | 20.0 | 20.0 |
| Total Calories (Kcal/day) | 1,030.0 | 1,206.6 | 1,295.8 |
| Calories/kg BW (ideal) | 17.5 | 16.7 | 16.5 |
| Calories from protein (Kcal/day) | 471.0 | 576.5 | 629.7 |
| Calories from fat (Kcal/day) | 327.0 | 398.1 | 434.1 |
| Calories from carbohydrates | 232.0 | 232.0 | 232.0 |
| (Kcal/day) | | | |
| Calories from protein (% Kcal/day) | 46% | 48% | 49% |
| Calories from fat (% Kcal/day) | 32% | 33% | 33% |
| Calories from carbohydrates | 23% | 19% | 18% |
| (% Kcal/day) | | | |

In some embodiments, overweight or obese individuals consuming the nutritional compositions see a 10% reduction in weight in 30 days. In other embodiments, overweight or obese individuals consuming the nutritional compositions see at least a 5% reduction in weight in 30 days. Some individuals find the nutritional compositions to be tasty and decide to indefinitely use them. These individuals maintain a healthy body weight as long as they use the nutritional compositions.

### EXAMPLE 7

Flavored Drink A: A flavored drink including the components in Table 4 is provided to a user.

TABLE 4

| Nutrient | 11 fl oz Serving |
|---|---|
| Calories (kcal) | 60.6 |
| Fat (g) | 2.0 |
| Saturated Fat (g) | 0.2 |
| Trans Fatty Acid (g) | 0.0 |
| Poly Fat (g) | 0.5 |
| Mono Fat (g) | 1.1 |
| Cholesterol (mg) | 3.6 |
| Carbohydrates (g) | 1.1 |
| Total Sugars (g) | 0.3 |
| Net Carbs (g) | 1.1 |
| Protein (g) | 9.5 |
| Total Omega 3 (mg) - Linolenic | 154 |
| Total Omega 6 (mg) | 321 |
| Sodium (mg) | 72 |
| Potassium (mg) | 215 |
| Vitamin A - IU (IU) | 2 |
| Vitamin C (mg) | 0.03 |
| Calcium (mg) | 194 |
| Iron (mg) | 0.08 |

Flavored Drink B: A flavored drink including the components in Table 5 is provided to a user.

TABLE 5

| Nutrient | 11 fl oz Serving |
|---|---|
| Calories (kcal) | 82.8 |
| Fat (g) | 2.0 |
| Saturated Fat (g) | 0.3 |
| Trans Fatty Acid (g) | 0.0 |
| Poly Fat (g) | 0.5 |
| Mono Fat (g) | 1.1 |
| Cholesterol (mg) | 6.0 |
| Carbohydrates (g) | 1.2 |
| Total Sugars (g) | 0.4 |
| Dietary Fiber (g) | 0.0 |
| Net Carbs (g) | 1.1 |
| Protein (g) | 14.7 |
| Total Omega 3 (mg) - Linolenic | 154 |
| Total Omega 6 (mg) | 321 |
| Sodium (mg) | 70.0 |
| Potassium (mg) | 225 |
| Vitamin A - IU (IU) | 3.2 |
| Vitamin C (mg) | 0.0 |
| Calcium (mg) | 304 |
| Iron (mg) | 0.1 |

Food Bar. A flavored food bar including the components in Table 6 is provided to a user.

TABLE 6

| Nutrient | 50 g Bar |
|---|---|
| Calories (kcal) | 179.0 |
| Fat (g) | 7.5 |
| Saturated Fat (g) | 1.1 |
| Trans Fatty Acid (g) | 0.0 |
| Poly Fat (g) | 1.9 |
| Mono Fat (g) | 3.5 |
| Cholesterol (mg) | 14.8 |
| Carbohydrates (g) | 23.2 |
| Total Sugars (g) | 3.8 |
| Dietary Fiber (g) | 3.3 |
| IMO Isomaltooligosaccharide (g) | 9.4 |
| Sugar Alcohol (g) | 5.1 |
| Net Carbs (g) | 5.4 |
| Protein (g) | 11.1 |
| Total Omega 3 (mg) - Linolenic | 427 |
| Total Omega 6 (mg) | 338 |
| Sodium (mg) | 140 |
| Potassium (mg) | 105 |
| Vitamin A - IU (IU) | 14 |
| Vitamin C (mg) | 0.14 |
| Calcium (mg) | 104 |
| Iron (mg) | 1 |

Biscuit: A flavored biscuit including the components in Table 7 is provided to a user.

TABLE 7

| Nutrient | 30 g Biscuit |
|---|---|
| Calories (kcal) | 140 |
| Fat (g) | 10.1 |
| Saturated Fat (g) | 2.2 |
| Trans Fatty Acid (g) | 0.0 |
| Poly Fat (g) | 1.6 |
| Mono Fat (g) | 4.7 |
| Cholesterol (mg) | 6.5 |
| Carbohydrates (g) | 12.4 |
| Total Sugars (g) | 2.7 |
| Dietary Fiber (g) | 3.3 |
| IMO Isomaltooligosaccharide (g) | 3.6 |
| Sugar Alcohol (g) | 1.2 |
| Net Carbs (g) | 4.3 |
| Protein (g) | 3.7 |
| Total Omega 3 (mg) - Linolenic | 262 |
| Total Omega 6 (mg) | 1,349 |

In some embodiments, a nutritional composition is provided to a user including various amounts of Flavored Drink A and Food Bar. In one embodiment, a composition includes 4×Flavored Drink A and 4×Food Bar per day to be split into eight daily food intakes.

In some embodiments, a nutritional composition is provided to a user including various amounts of Flavored Drink B and Biscuit. In one embodiment, a composition includes 4×Flavored Drink B and 4×Biscuit per day to be split into eight daily food intakes.

In some embodiments, a nutritional composition is provided to a user including various amounts of Flavored Drink B and Food Bar. In one embodiment, a composition includes 4×Flavored Drink B and 4×Food Bar per day to be split into eight daily food intakes.

In some embodiments, a nutritional composition is provided to a user including various amounts of Flavored Drink A and Biscuit. In one embodiment, a composition includes 4×Flavored Drink A and 4×Biscuit per day to be split into eight daily food intakes.

In some embodiments, a nutritional composition is provided to a user including various amounts of Flavored Drink A and Flavored Drink B. In one embodiment, a composition includes 4×Flavored Drink A and 4×Flavored Drink B per day to be split into eight daily food intakes.

In some embodiments, a composition can include various combinations of Flavored Drink A, Flavored Drink B, Food Bar, and Biscuit as desired by a user. Combinations can be provided to achieve a particular macronutrient intake per day.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

The terms “a,” “an,” “the” and similar referents used in the context of describing the invention (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain embodiments of this invention are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the invention to be practiced otherwise than specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

Furthermore, numerous references have been made to patents and printed publications throughout this specification. Each of the above-cited references and printed publications are individually incorporated herein by reference in their entirety.

In closing, it is to be understood that the embodiments of the invention disclosed herein are illustrative of the principles of the present invention. Other modifications that may be employed are within the scope of the invention. Thus, by way of example, but not of limitation, alternative configurations of the present invention may be utilized in accordance with the teachings herein. Accordingly, the present invention is not limited to that precisely as shown and described.

1. A nutritional composition including:
less than about 35 g of net carbohydrate;
at least 10 mg of fiber; and
about 1.0 g to about 2.5 g of protein per kilogram of an individual's body weight and that individual's height,
wherein the nutritional composition comprises at least five intakes per day.

2. The nutritional composition of claim 1, wherein the nutritional composition is in a liquid dosage form, in a solid dosage form, in a powder dosage form, or in a combination of forms.

3. The nutritional composition of claim 1 including about 100 g to about 200 g of net carbohydrate per day.

4. The nutritional composition of claim 1 further including about 2,000 mg to about 12,000 mg of omega 3 per day.

5. The nutritional composition of claim 4 further including an omega 6.

6. The nutritional composition of claim 5, wherein the ratio of omega 3 to omega 6 is about 1:1.

7. The nutritional composition of claim 1 further including at least one amino acid selected from phenylalanine, valine, threonine, tryptophan, methionine, leucine, isoleucine, lysine and histidine.

8. The nutritional composition of claim 7 including all amino acids humans cannot synthesize.

9. The nutritional composition of claim 1 including at least about 15 g of fiber per day.

10. The nutritional composition of claim 1 including from about 10 g to about 50 g of fiber per day.

11. The nutritional composition of claim 1 further including less than about 150 mg of cholesterol per day.

12. The nutritional composition of claim 1, wherein the nutritional composition further comprises a component selected from the group consisting of vitamins, minerals, essential amino acids, or a combination thereof.

13. The nutritional composition of claim 1, wherein the nutritional composition comprises at least five daily intakes.

14. A nutritional composition of claim 1 for use as a medicament to treat obesity.

15. A nutritional composition of claim 1 for use as a medicament for treating diabetes.

16. A nutritional composition of claim 1 for use as a medicament for treating cancer.

17. A nutritional composition of claim 1 for use as a medicament for treating cardiovascular disease.

18. A nutritional composition of claim 1 for use as a medicament for treating arthritis.

19. A nutritional composition of claim 1 for use as a medicament for treating weight gain.

20. A system comprising:
a set of at least four biscuits and four beverages for a daily dose of less than about 35 g of net carbohydrate; at least 10 mg of fiber; and about 1.0 g to about 2.5 g of protein per kilogram of an individual's body weight and that individual's body height; and a unifying container.
